(19) United States
(12) Patent Application Publication
(10) Pub. No.: US 2015/0249873 A1
(43) Pub. Date: Sep. 3, 2015

(54) VIDEO BROADCAST OF CUSTOMER REVIEWS

(71) Applicant: David Sprague, Jupiter, FL (US)

(72) Inventor: David Sprague, Jupiter, FL (US)

(73) Assignee: REAL STRATEGIC INC., Jupiter, FL (US)

(21) Appl. No.: 14/194,889

(22) Filed: Mar. 3, 2014

(51) Int. Cl. H04N 21/8549; H04N 21/475; H04N 21/61; H04N 21/44; H04N 21/433; H04N 21/2743; H04N 21/482; H04N 21/81

(52) U.S. Cl. CPC H04N 21/8549; H04N 21/482; H04N 21/4756; H04N 21/8173; H04N 21/44; H04N 21/433; H04N 21/2743; H04N 21/6175

(57) ABSTRACT

A processor implemented method of enabling video broadcast of reviews includes connecting social media profiles of a user to a web portal, receiving video settings at a user interface, displaying a list of reviews, accepting from the user a selection of from the list of reviews, creating a review video, generating a posting queue and publishing the selected review to the social media profile associated with the user in the form of the review video.

### FIELD OF TECHNOLOGY

The present invention relates to a method, system and/or apparatus for video broadcast of customer reviews.

### BACKGROUND

The advent of the World Wide Web (“Web”) has created a widespread phenomenon of review systems, which are essentially systems that support the reviews of particular items by large, self-selected groups of non-professional reviewers. This has the disadvantage of users being unable to present the right reviews to prospective future users of a system or service.

Systems available for use in the area generally provide aggregation of user ratings, for example, an overall average user rating, or a ranking of a given item (book, movie, hotel, or restaurant, etc.) among a group of items. Some systems allow for multi-dimensional ratings or inputs.

There is lack of effective utilization and portrayal mechanism for users to show reviews for the users' products/services in a highlighted manner through various channels on the internet.

There is lack of effective utilization and portrayal mechanism for customers' reviews to be shown in a manner that is easy for viewing and understanding.

### SUMMARY

Disclosed are a method, an apparatus and/or a system of video broadcast of customer reviews.

In one aspect, a method includes connecting a social media profile associated with a user to a web portal and receiving video settings through a user interface. A list of reviews is displayed to the user through the user interface. The method further includes, accepting from the user a selection of review(s) from the list of reviews. A review video is created using the selected reviews and in responsive to receipt of a command to share the review video at the first processor system, generating a posting queue. Additionally, responsive to receipt of a post now command, the method also includes generating and publishing the review video to the social media profile associated with the user.

In another aspect, a data processing device includes a processor that executes instructions and a memory having instructions when executed by the processor that causes the device to connect social media profile associated with a user to a web portal. The device includes a means to receive video settings at a first processor system through a user interface associated with the web portal and display a list of reviews through the user interface. Further, the device accepts from the user a selection of review(s) from the list of reviews. The device creates a review video through an associated video generator. The device in responsive to receipt of a command to share the selection at the first processor system, generates a posting queue and in responsive to receipt of a post now command, generates and publishes the review video to the social media profile(s) associated with the user.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a system of video broadcasting reviews onto social media, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of video broadcast of customer reviews, according to one or more embodiments.

FIG. 4 is a process flow diagram detailing the operations of posting a review video onto a social media site, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of video broadcasting of customer reviews. Although the present embodiments have been described with reference to specific example embodiments, it will be evident that various modifications and changes may be made to these embodiments without departing from the broader spirit and scope of the various embodiments.

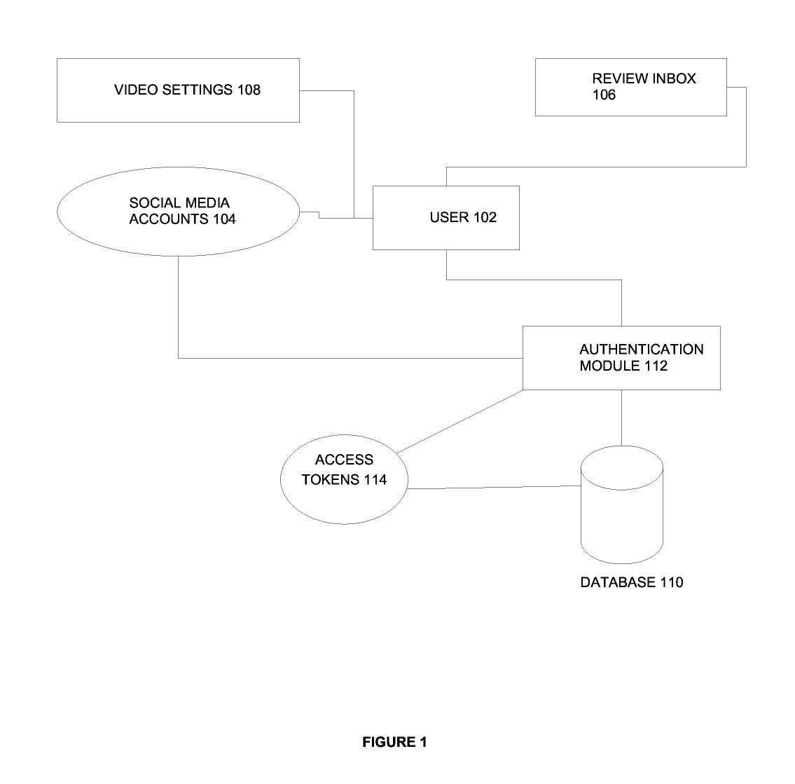

FIG. 1 is a block diagram detailing components involved in video based broadcasts of user reviews, according to one or more embodiments. In one or more embodiments, a system for video broadcasting of reviews may include a user 102 associated with a user interface coupled to a processor. Further, the user 102 may provide access details of an online account(s) 104. The access details provided by the user 102 may be processed by an authentication module 112. The authentication module 112 may be communicatively coupled to a computer database 110 that stores access tokens 114. The access details provided by the user 102 may be stored as the access tokens 114 in the database 110.

In one or more embodiments, after the user 102 provides authentication details the user 102 may be requested to provide video settings 108. The video settings 108 may be one of an image, a logo, a name, video description, and/or video background. In an example embodiment, a user may upload a branding image, a company logo and name. In another example embodiment, a user may be prompted to upload a background image and a description for a review video.

In an example embodiment, a processor implemented method of enabling video based broadcast of reviews may include connecting an online account of a user to a web portal and in response, receiving a prompt to provide video settings at a user interface. A list of reviews may be displayed on a user interface. A selection of from the list of reviews may be accepted from the user. In response to the selection, a posting queue may be generated and displayed on the user interface. The selected review may be published as a video to the online account associated with the user.

In one or more embodiments, a processor implemented method of video based user review broadcasting may include connecting a social media profile associated with a user to a web portal. In response to the connection, a user interface may display a prompt to provide video settings at a first processor system connected to the web portal. A list of reviews may be displayed to the user through the user interface. A selection of review(s) may be accepted from the list of reviews. Responsive to receipt of a command to share the selection at the first processor system, a posting queue may be generated. Further, responsive to receipt of a post now command, the selected review(s) may be generated and published in the form of a custom video to the online account associated with the user.

In one or more embodiments, the online account associated with the user may be a user account in a social media service (E.g., FacebookTM, TwitterTM and PinterestTM), video hosting service, blog, website, and/or video broadcasting service (E.g., YoutubeTM and DailyMotionTM).

In one or more embodiments, a method of broadcasting a unique video of a review associated with a service/product may include connect an online account such as social media account of a user with a web portal. The user may be prompted to provide a set of video settings that the review video would be based on. The video settings may include uploading a branding logo, entering an organization name, choosing and/or uploading a background image, choosing a video background, and/or setting up a video description. The Review video may be added onto a post queue section. The post queue section may be a queue wherein contents of the queue are posted to the online account(s) associated with the web portal. The contents from the queue may be sent to a video processor to apply video settings. The review video may be posted to the online account that may include one of a social media service (E.g., Facebook™, Twitter™ and Pinterest™), video hosting service, blog, website, and/or video broadcasting service (E.g., Youtube™ and DailyMotion™). Once the review video has been posted to the online account(s), the video may be removed from the post queue section and added onto a posted queue section.

In one or more embodiments, the post queue may be generated to a log table associated with memory storage. In one or more embodiments, authentication access to the online account may be recorded in the process of connecting to the web portal. Upon successful authentication of the online account(s), an account access token may be received.

In one or more embodiments, the video settings may be one of an image, a logo, a name, video description, and/or video background. Further, the image may refer to branding image that an organization uses. The logo and name may refer to the organization's logo and name. The video background may refer to a background image that the review video may include. The video description may be received as an input from the user.

In one or more embodiments, the account access token may be utilized for publishing the selected review(s) as video. Further, the review video may be associated with a video format. The video formats may be one of H.261, H.263, H.264, M-PEG, MPEG-1, MPEG-2, MPEG-4 AVI, Ogg, Theora, VC-1 as well as derivatives and combinations of these types.

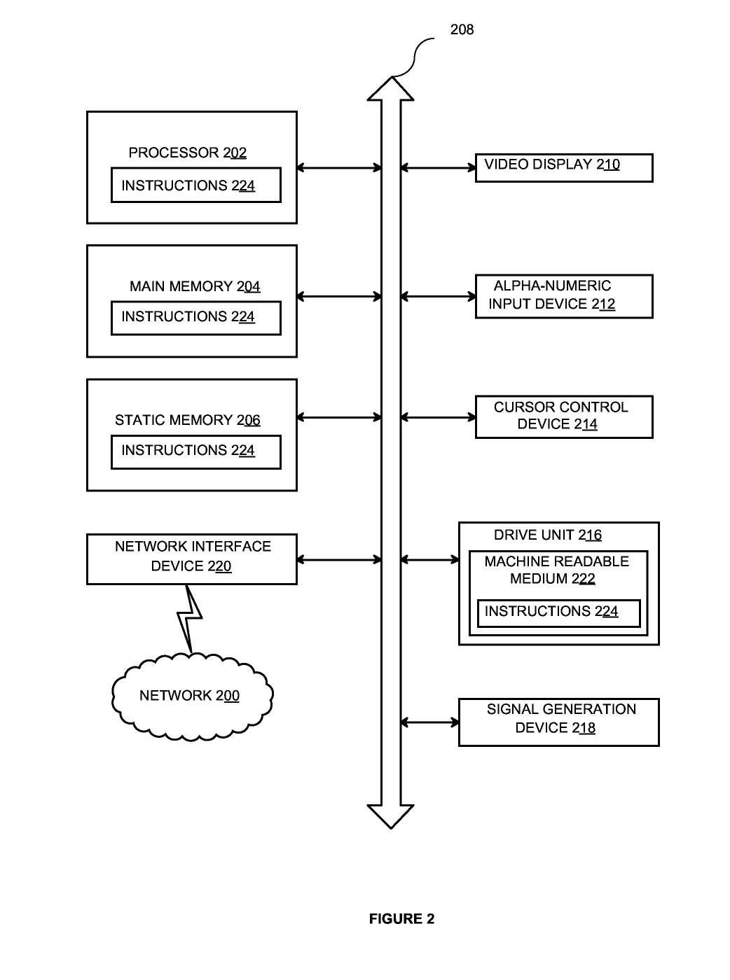

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal—computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

For example, social media services/platforms may be social networking services such as Facebook™, Twitter™, and Pinterest™. In one or more embodiments, social networking services may require users to register before using the social networking services, after which the users may create a personal profile, add other users as friends, exchange messages, and receive automatic notifications when the users update the personal profile. Additionally, users may join common-interest user groups, organized by workplace, school and/or college and/or university, or other characteristics, and categorize friends into lists such as “People From Work” or “Close Friends”. Further, social network services may allow users to follow activities and posts of other users.

For example, video broadcasting and video hosting services may be services such as Youtube™ and Dailymotion™. In one or more embodiments, video broadcasting and video hosting services may require users to register before using the video broadcasting and video hosting services, after which the users may create a personal profile, add other users as friends, exchange messages, and receive automatic notifications when the users update a personal profile associated with the video hosting and/or video broadcasting services.

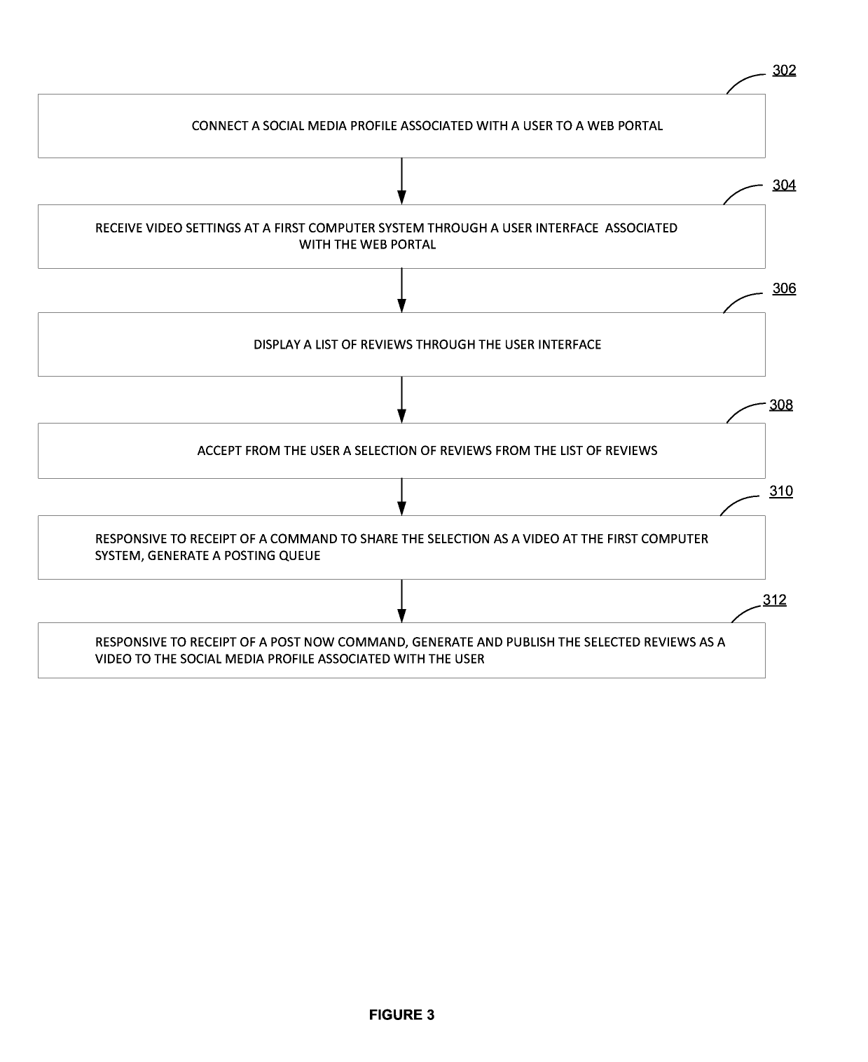

FIG. 3 is a process flow diagram detailing the operation of a method of posting review(s) through videos onto online platforms. Posting reviews as videos onto social media platforms may include a step of providing a connection to social media profiles associated with the user to the web portal 302. The web portal may be provided with access to the user's personal information such as messages, posts onto social platform(s), videos and images. Further, the method may include seeking video settings that may be received at a first computer system through a user interface associated with the web portal 304. Further, the method includes displaying a list of reviews through the user interface 306. Still further, accepting from the user a selection of reviews from the list of reviews 308. A posting queue may be generated in response to a command from the user to share 310. Also, in response to a post now command, the selected reviews may be generated onto a review video and posted onto social media profile(s) 312. In one or more embodiments, a social media profile may be associated with the user, organization that a user may have affiliation to, group of individuals and/or organization.

In an example embodiment, reviews from users may be collected and/or scrapped from multiple websites. The reviews may be stored in a computer database. The reviews may be presented to a user of a review aggregation and publishing system that publishes reviews as custom videos. The custom videos may include one of an opening part, middle part, closing part and a call to action. The custom video may be a unique video wherein a random selection algorithm may make selections from amongst sets of opening parts, middle parts, closing parts and calls to action. In an example embodiment, a user may make selections of a specific sequence from a list of opening parts, middle parts, closing parts and calls to action. In example embodiment, a video review posting system may offer an option to create 600,000 unique videos when there are 30 openings, 30 middles, 30 closes and 30 calls to actions to choose from for a user.

In one or more embodiments, the review video may be automatically posted to the online account associated with the user.

In one or more embodiments, a video broadcast of customers online and offline reviews may include connecting online accounts, setting up video options and video broadcasting. Connecting online accounts may include connecting video broadcasting sites (E.g., YoutubeTM and DailymotionTM) to a web portal. Further, connecting online accounts may include an authentication process. In an example embodiment, the authentication process may include authenticating online accounts using procedures such as OAuth 2.0. On successful authentication the web portal may receive access tokens. In an example embodiment, the setting up video options may include setting up a background (e.g., background image that is default or uploaded), setting up a Company Logo and Name and setting up video descriptions.

In an example embodiment, the video broadcasting may include user providing an input on a review inbox to publish a review. Once the user provides the input a posting queue may be generated with a post now option. If the user chooses the post now option a review video may be posted to the connected online accounts using the access tokens.

In an example embodiment, a system of broadcasting videos of reviews may include selecting an opening part (E.g., a transparent MOV file) a folder. The opening part may be layered on an image file provided by user and/or system default. A lower third of the image file may be generated by using PHP Image Manipulation. So that company logo, company title and phone number may be embedded on lower third image. The file may be further saved as a PNG file. A closing part (transparent MOV file) may be randomly selected from another folder and over layered on the image file provided by user and/or system default. The Lower third file may be then overlaid on opening and closing parts and saved as mp4 video image using AVCONV command line. The system may then offer one or more php templates which may be snapped with a website screenshot service such as grabzlTTM.

In an example embodiment, two php based templates which may be snapped with grabzIT so that a middle session/part and call to action image may be generated.

The images such as middle session/part and call to action may then be looped with audios offered by the system for middle part and Calls to action. A looped information may then be saved as mp4 video image. Finally, the system may concatenate multiple parts using a streaming service such as ffmpegTM and save the concatenation as final video.

In another example embodiment, the user selects a set of reviews that the user wants to be present in a review video. The review video may be a aggregation of multiple text based reviews in the form of a video that is mashed with randomly selected opening, middle, closing and call to action sequences. The review video may include one of a reviewer name, review website, date, website, rating, feedback, background music, and additions offered by a web portal such as opening part, middle part, closing part, and call to action. Further, the review video may be posted to one or more social media service providing sites.

In another example embodiment, reviews may be collected from one or more websites such as Yelp, and Urbanspoon. Further, reviews may be collected from social media sites such as Twitter™.

In an example embodiment, reviews of a service may be collected from one or more websites and stored onto a computer database. Further, the collected reviews may be aggregated into a review video. The review video may be posted onto a social media site after combining with multiple offerings from a review broadcasting service. The multiple offerings may include generating a unique video based on a combination as shown in Table 1.

TABLE 1
Actor 1

| Opening | Middle | Close | Call to action |
|---|---|---|---|
| 26 videos | 26 MP3s | 25 videos | 25 MP3s |

Table 1 shows example tabulation for actor 1. A video layout for actor 1 may include a video layout/sequence as shown in table 2 wherein the actor video is followed by showing a review while background MP3 music plays followed by a video of actor speaking again which finally followed by a billboard.

TABLE 2
video layout/sequence

| Video: 4 | MP3: 21 | Video: 8 | MP3: 2 |
|---|---|---|---|
| Actor | Show review | Actor | Billboard |

In an example embodiment, reviews for a service and/or product may be collected. The collected review may include one of a reviewer detail, review rating, date of review, time of review, review site, and contact detail of the reviewed service and/or product. The collected reviews may be added onto a review directory. A user may be presented with the list of collected reviews to choose from. The chosen reviews may be added to a video layout. The video formed from the chosen reviews may include one of a reviewer detail, review rating, date of review, time of review, review site, and contact detail of the reviewed service and/or product. The video formed from the chosen review(s) may be posted onto a social media service such as Facebook™, Twitter™ and/or Pinterest™.

The collection of reviews may be done through one of scraping off multiple websites, receiving reviews through email, Multimedia messaging service, instant messaging services and so on. In one or more embodiments, a review directory may be a listing of all reviews pertaining to a service and/or product. In one or more embodiments, a review directory may be a certain section of a social media service dedicated to the service and/or product e.g Product page on Facebook™.

In an example embodiment, reviews for a service and/or product may be collected. The collected review may include one of a reviewer detail, review rating, date of review, time of review, review site, and contact detail of the reviewed service and/or product. The collected reviews may be added onto a review directory. A user may be presented with the review directory to choose from. The chosen reviews may be added to a video layout to create a review video. The review video formed from the chosen reviews may include one of a reviewer detail, review rating, date of review, time of review, review site, and contact detail of the reviewed service and/or product. The review video formed from the chosen review may be posted onto a social media service such as Facebook™, Twitter™ and/or Pinterest™.

In one or more embodiments, a processor implemented method of posting video based reviews onto social media site(s) may include aggregating reviews for one of a service and a product from websites through the processor. The aggregated reviews may be collected onto a computer database. A user may be presented the aggregated reviews from websites through a user interface at a processor driven computer display. One or more social media profiles associated with the user may be connected to the web portal. and the review video may be posted onto a social media site through the web portal.

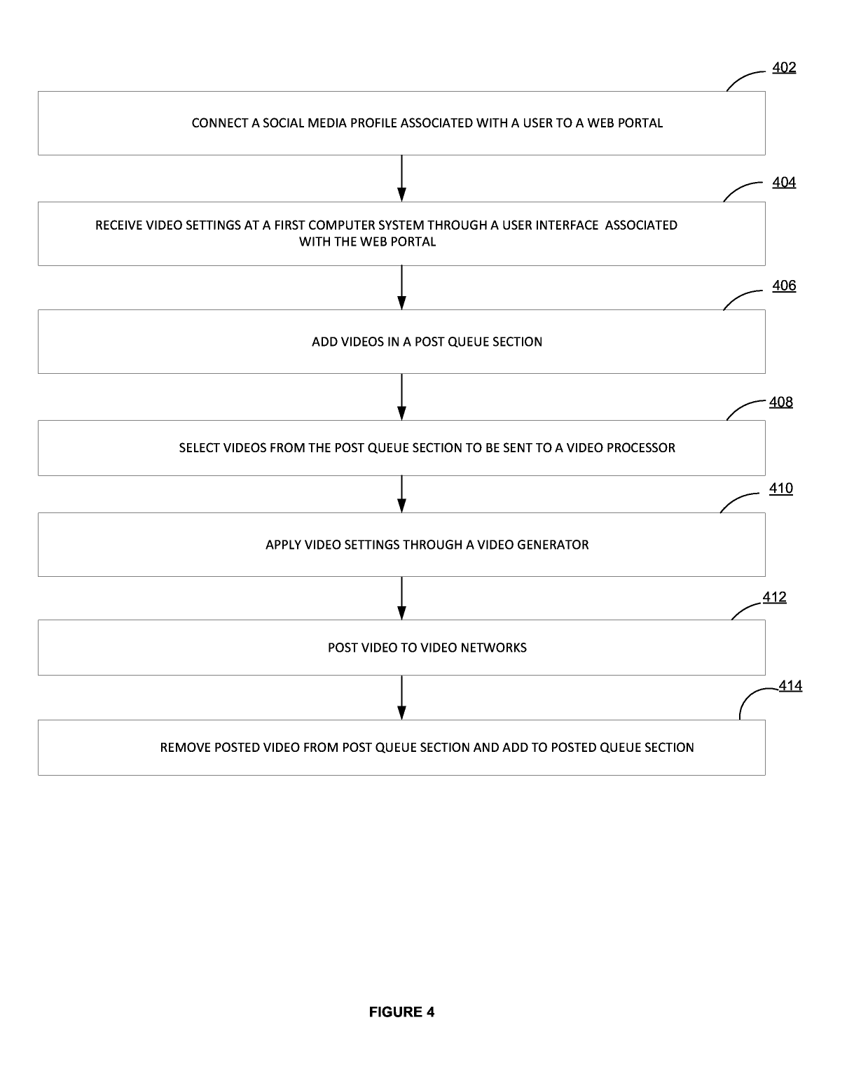

FIG. 4 is a process flow diagram detailing the operations of creating posting a review video onto social media platforms, according to one or more embodiments. A method of broadcasting a unique video of a review associated with a service/product may include connect an online account such as social media account of a user with a web portal 402. The user may be prompted to provide a set of video settings 404 that the review video would be based on. The video settings may include uploading a branding logo, entering an organization name, choosing and/or uploading a background image, choosing a video background, and/or setting up a video description. The Review video may be added onto a post queue section 406. The post queue section may be a queue wherein contents of the queue are posted to the online account(s) associated with the web portal. The contents from the queue may be sent to a video processor to apply video settings 408. Video setting may be applied through a video generator 410. The review video may be posted to the online account that may include one of a social media service (E.g., Facebook™, Twitter™ and Pinterest™), video hosting service, blog, website, and/or video broadcasting service (E.g., Youtube™ and DailyMotion™) 412. Once the review video has been posted to the online account(s), the video may be removed from the post queue section and added onto a posted queue section 414.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A processor implemented method comprising:
connecting at least one online account associated with a user to a web portal;
authenticating the connected online account with the online account provider;
receiving video settings from the user at a first processor system through a user interface associated with the web portal;
displaying a list of reviews through the user interface;
accepting from the user a selection of at least one review from the list of reviews;
creating a review video through a video generator;
responsive to receipt of a command to share the review video at the first processor system, generating a posting queue; and
responsive to receipt of a post now command, generating and publishing the review video to the at least one online account associated with the user.

2. The processor implemented method of claim 1, further includes:
generating the posting queue to a log table associated with a memory storage.

3. The processor implemented method of claim 1 further includes:
upon successful authentication of the at least one online account, receiving an account access token.

4. The processor implemented method of claim 1 further includes:
wherein the video settings are at least one of an image, a logo, a name, video description, and video background.

5. The processor implemented method of claim 1 further includes:
utilizing the account access token for publishing the review video.

6. The processor implemented method of claim 1, wherein the video is associated with a video format.

7. The processor implemented method of claim 1, wherein the video format is selected from a set of video formats including: H.261, H.263, H.264, M-PEG, MPEG-1, MPEG-2, MPEG-4 AVI, Ogg, Theora, VC-1 as well as derivatives and combinations of these types.

8. A data processing device comprising:
a processor that executes instructions;
a memory having instructions when executed by the processor, that causes the data processing device to:
connect at least one online account associated with a user to a web portal;
receive video settings at a first processor system through a user interface associated with the web portal;
display a list of reviews through the user interface;
accept from the user a selection of at least one review from the list of reviews;
create a review video through a video generator;
responsive to receipt of a command to share the selection as the review video at the first processor system, generate a posting queue; and
responsive to receipt of a post now command, generate and publish the review video to the at least one social media profile associated with the user.

9. The device of claim 9, wherein the posting queue is generated and stored into to a log table associated with a memory storage.

10. The device of claim 9, wherein the at least one online account is authenticated in the process of connecting to the web portal.

11. The device of claim 9, wherein upon successful authentication of the at least one online account, an account access token is received.

12. The device of claim 9, wherein the video settings are at least one of an image, a logo, a name, video description, and video background.

13. The device of claim 9, wherein the account access token is utilized for publishing the selected at least one review as a video.

14. The device of claim 14, wherein the video is associated with a video format.

15. The device of claim 15, wherein the video format is selected from a set of video formats including: H.261, H.263, H.264, M-PEG, MPEG-1, MPEG-2, MPEG-4 AVI, Ogg, Theora, VC-1 as well as derivatives and combinations of these types.

16. A processor implemented method comprising:
aggregating reviews for at least one of a service and a product from sources through the processor onto a web portal;
collecting the aggregated reviews onto a computer database associated with the web portal;
presenting a user the aggregated reviews from websites through a user interface at a processor driven computer display;
accepting from the user a selection of reviews to be added onto a review video, wherein the selection is a subset of the aggregated reviews;
creating the review video;
connecting at least one online account associated with a user to the web portal; and
posting the review video onto a website through the processor.
